(19) United States
(12) Patent Application Publication
(10) Pub. No.: US 2017/0315285 A1
(43) Pub. Date: Nov. 2, 2017

(54) LIGHT ADJUSTMENT FILM AND BACKLIGHT MODULE USING THE SAME

(71) Applicant: Coretronic Corporation, Hsin-Chu (TW)

(72) Inventors: Liang-Tse Chen, Hsin-Chu (TW); Chao-Hung Weng, Hsin-Chu (TW); Ching-Tang Yang, Hsin-Chu (TW); Min-Yi Hsu, Hsin-Chu (TW)

(21) Appl. No.: 15/652,178

(22) Filed: Jul. 17, 2017

Related U.S. Application Data
(63) Continuation-in-part of application No. 14/489,993, filed on Sep. 18, 2014.

(30) Foreign Application Priority Data
Jul. 22, 2016 (TW) 105211088

(51) Int. Cl. F21V 8/00

(52) U.S. Cl. CPC G02B 6/005; G02B 6/0058; G02B 6/0051; G02B 6/0053; G02B 6/0055

(57) ABSTRACT

A light adjustment film is provided. The light adjustment film includes a substrate and a first light adjustment structure layer. The substrate has a first surface and a second surface opposite to each other. The first light adjustment structure layer is disposed on the first surface of the substrate. The first light adjustment structure layer includes a plurality of light adjustment structures. Each of the light adjustment structures has a long axis, a short axis and a thickness. The long axis of the light adjusting structures is parallel to an extending direction. The light adjusting structures are composed of at least 100 types of structures having different shapes from each other. A backlight module having the aforementioned light adjustment film is also provided.

### CROSS-REFERENCE TO RELATED APPLICATION

THIS APPLICATION CLAIMS THE PRIORITY BENEFIT OF Ser. No. 14/489,993 FIELD ON Sep. 18, 2014 AND TW105211088 FILED ON Jul. 22, 2016. THE ENTIRETY OF THE ABOVE-MENTIONED PATENT APPLICATIONS IS HEREBY INCORPORATED BY REFERENCE HEREIN AND MADE A PART OF THIS SPECIFICATION.

### FIELD OF THE INVENTION

The invention relates to a light adjustment film, and more particularly to a light adjustment film for a backlight module.

### BACKGROUND OF THE INVENTION

Backlight module is composed of a reflection sheet, a diffusion sheet, a prism film, a light guide plate and a light source, wherein the light guide plate is one of the most important components in the backlight module. The principle of light guide plate is to use the total reflection principle to transmit the light beam from the light source to the far end of the light guide plate, use the dot patterns on the bottom surface of the light guide plate to destroy the total reflection of the light beam, and then guide the light beam to the light exit surface of the light guide plate.

Please refer to FIG. 1A, which is a schematic cross-sectional view of a conventional backlight module 1. As shown in FIG. 1A, the backlight module 1 includes a light source 11, an inverse prism film 12, a diffusion sheet 13, a light guide plate 14 and a reflection sheet 15. The light guide plate 14 has a side surface 141, a light exit surface 142 and a bottom surface 143. The light source 11 is disposed beside the side surface 141 of the light guide plate 14; the inverse prism film 12 and the diffusion sheet 13 are disposed above the light exit surface 142 of the light guide plate 14; and the reflection sheet 15 is disposed below the bottom surface 143 of the light guide plate 14.

The light guide plate 14 makes the light beam from the light source 11 travel in the light guide plate 14 by using the principle of total reflection so that the light beam can emit out from the light exit surface 142. The reflection sheet 15 reflects a part of the light beam from the bottom surface 143 back into the light guide plate 14 to increase the usage efficiency of the light beam. The light beam emitted out from the light exit surface 142 of the light guide plate 14 passes through the inverse prism film 12 and then is emitted to a liquid crystal panel (not shown) via the diffusion sheet 13.

After the light beam is emitted out from the light guide plate 14 of the backlight module 1, the traveling direction of the light beam is corrected by the inverse prism structure 121 provided in the inverse prism film 12 so that the backlight module 1 can increase the proportion of light exiting perpendicularly from the light exit surface 142.

Please refer to FIG. 1B, which is a viewing view of the horizontal and vertical viewing angles of the outgoing light beam of FIG. 1A. As shown in FIG. 1B, the structure of the backlight module 1 has a problem that the vertical viewing angle is too small. Specifically, the viewing angle of the backlight module 1 depends on the inverse prism film 12. That is, the outgoing light beam of the backlight module 1 mounted with the inverse prism film 12 may have a problem that the horizontal viewing angle (the direction X) and the vertical viewing angle (the direction Y) have a too large difference, which may lead to visual discomfort when the user rotates the screen and views the screen in different directions. Therefore, how to solve the above-mentioned problems is one of the important things for the persons in the field. If another perpendicular inverse prism film is added, not only the problem of too small viewing angle cannot be solved but also brightness will be reduced and interference fringes will be produced. If another diffusion sheet is added, there may be a problem that interference fringes are produced with the inverse prism film.

The information disclosed in this “BACKGROUND OF THE INVENTION” section is only for enhancement understanding of the background of the invention and therefore it may contain information that does not form the prior art that is already known to a person of ordinary skill in the art. Furthermore, the information disclosed in this “BACKGROUND OF THE INVENTION” section does not mean that one or more problems to be solved by one or more embodiments of the invention were acknowledged by a person of ordinary skill in the art.

### SUMMARY OF THE INVENTION

One objective of the invention is to provide a light adjustment film for a backlight module to achieve the effects of high brightness and large viewing angle.

Another objective of the invention is to provide a backlight module having a light adjustment film for achieving the effects of high brightness and large viewing angle.

Other objectives and advantages of the invention can be further illustrated by the technical features broadly embodied and described as follows.

In order to achieve one or a portion of or all of the objects or other objects, the invention provides a light adjustment film, which includes a substrate and a first light adjustment structure layer. The substrate has a first surface and a second surface opposite to each other. The first light adjustment structure layer is disposed on the first surface of the substrate. The first light adjustment structure layer includes a plurality of light adjustment structures. Each of the light adjustment structures has a long axis, a short axis and a thickness. The long axis of the light adjustment structures is parallel to an extending direction. The light adjustment structures are composed of at least 100 types of structures having different shapes from each other.

In order to achieve one or a portion of or all of the objects or other objects, the invention provides a backlight module, which includes a light guide plate, a light source, a prism film, the aforementioned light adjustment film and a reflection sheet. The light guide plate has a light entrance surface, a light exit surface and a bottom surface opposite to the light exit surface. The light source is disposed beside the light entrance surface of the light guide plate to provide a light beam to the light guide plate. The prism film is disposed above the light exit surface of the light guide plate. The light adjustment film is disposed above the prism film. The reflection sheet is disposed below the bottom surface of the light guide plate.

In summary, the embodiments of the invention have at least one of the following advantages. The light adjustment film of the embodiment of the invention has a light adjustment structure layer including a plurality of light adjustment structures which is composed of at least 100 types of structures having different shapes from each other. By applying the light adjustment film of the embodiment of the invention to a backlight module, the vertical viewing angle of the inverse prism film is expanded effectively, the vertical viewing angle and the horizontal viewing angle are more symmetrical and the visual defects of hot spots and muras are avoided effectively.

Other objectives, features and advantages of the invention will be further understood from the further technological features disclosed by the embodiments of the invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A is a schematic cross-sectional view of a conventional backlight module;

FIG. 1B is a viewing view of the horizontal and vertical viewing angles of the outgoing light beam of FIG. 1A;

FIG. 2 is a schematic cross-sectional view of a light adjustment film in accordance with an embodiment of the invention;

FIG. 3 is a schematic top view of the light adjustment film shown in FIG. 2;

FIG. 4 is a schematic top view of a light adjustment film in accordance with another embodiment of the invention;

FIG. 5 is a schematic top view of a light adjustment film in accordance with another embodiment of the invention;

FIG. 6 is a schematic cross-sectional view of a light adjustment film in accordance with another embodiment of the invention;

FIG. 7A is a schematic partial perspective view of a backlight module in accordance with an embodiment of the invention;

FIG. 7B is a viewing view of the horizontal and vertical viewing angles of the outgoing light beam of FIG. 7A;

FIG. 8 is a partial perspective structural view of a backlight module in accordance with another embodiment of the invention;

FIG. 9A is a graph showing the relationship between the ratio of the short-axis length to the long-axis length and the viewing angle and the luminance in the case where the thickness of the light adjustment structure is 2 um;

FIG. 9B is a graph showing the relationship between the ratio of the short-axis length to the long-axis length and the viewing angle and the luminance in the case where the thickness T of the light adjustment structure is 4 um; and

FIG. 9C is a graph showing the relationship between the ratio of the short-axis length to the long-axis length and the viewing angle and the luminance in the case where the thickness T of the light adjustment structure is 6 um.

### DETAILED DESCRIPTION OF PREFERRED EMBODIMENTS

In the following detailed description of the preferred embodiments, reference is made to the accompanying drawings which form a part hereof, and in which is shown by way of illustration specific embodiments in which the invention may be practiced. In this regard, directional terminology, such as “top”, “bottom”, “front”, “back”, etc., is used with reference to the orientation of the Figure(s) being described. The components of the invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the invention. Also, it is to be understood that the phraseology and terminology used herein are for the purpose of description and should not be regarded as limiting. The use of “including”, “comprising”, or “having” and variations thereof herein is meant to encompass the items listed thereafter and equivalents thereof as well as additional items. Unless limited otherwise, the terms “connected”, “coupled”, and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

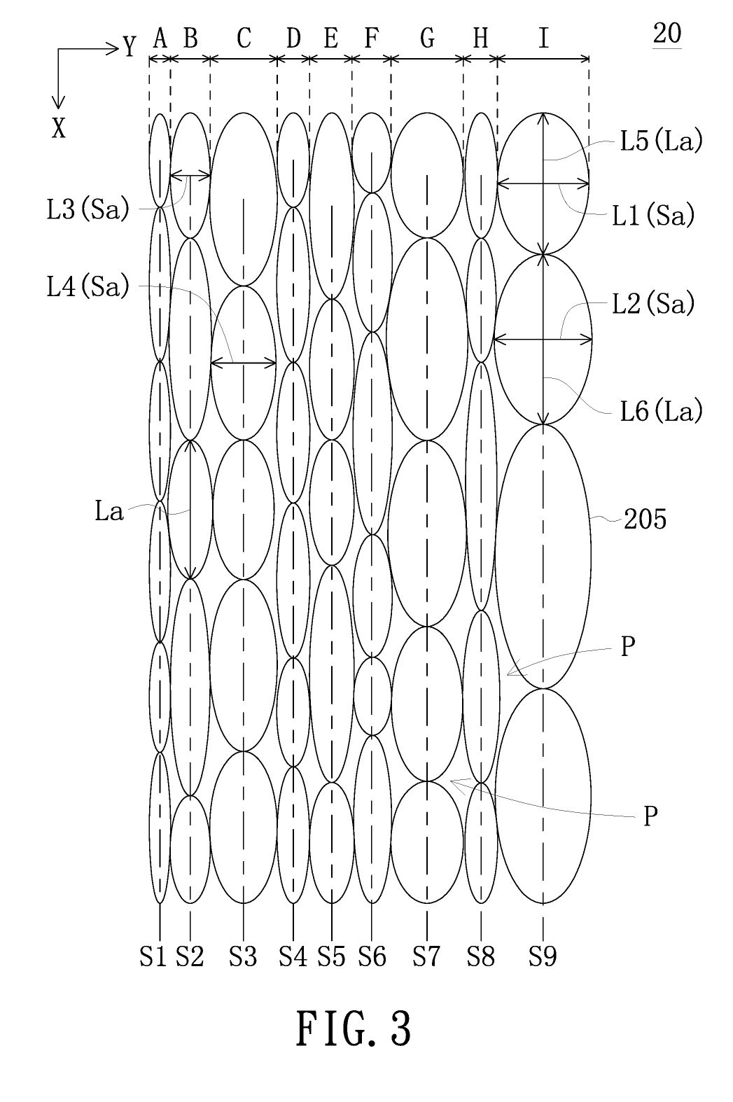

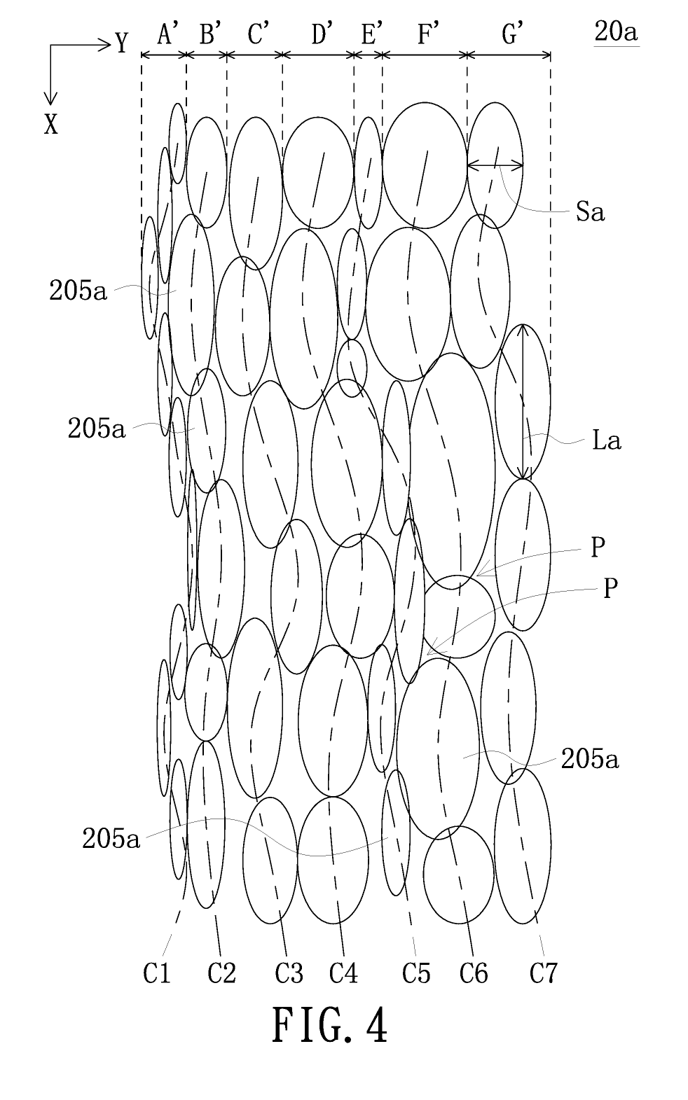

FIG. 2 is a schematic cross-sectional view of a light adjustment film 20 in accordance with an embodiment of the invention. FIG. 3 is a schematic top view of the light adjustment film 20 shown in FIG. 2. As shown in FIG. 2, the light adjustment film 20 of the embodiment includes a substrate 201 and a first light adjustment structure layer 202. The substrate 201 has a first surface 203 and a second surface 204 opposite to each other. The first light adjustment structure layer 202 is disposed on the first surface 203 of the substrate 201, and the first light adjustment structure layer 202 includes a plurality of light adjustment structures 205. In the embodiment as shown in FIG. 3, each of the light adjustment structures 205 extends in the direction X; each of the light adjustment structures 205 has a long axis La and a short axis Sa; and the long axis La of each of the light adjustment structures 205 is parallel to the direction X. As shown in FIG. 2, each of the light adjustment structures 205 of the embodiment has a thickness T. These aforementioned light adjustment structures 205 are composed of at least 100 types of structures having different shapes from each other. In addition, the second surface 204 may be a mirror or rough surface. It should be noted that the number/quantity of the light adjustment structures 205 depicted in FIGS. 2 and 3 represents only a portion of the light adjustment structures 205 of the embodiment, and is not representative of the total number.

In the embodiment, these light adjustment structures 205 are composed of at least 100 types of structures having different shapes from each other, and therefore are capable of preventing the issue of moiré pattern caused by interference in the case where the shape of these light adjustment structures 205 has a regular change. By composing these light adjustment structures 205 with at least 100 types of structures having different shapes from each other allows the shape of these light adjustment structures 205 has an irregular change and thereby avoiding the interference of these light adjustment structures 205. It is to be noted that, in addition to using at least 100 types of the light adjustment structures 205 having different shapes from each other, the number of types of structures having different shapes from each other may be further limited to at most 2,000. That is, the number of types of the light adjustment structures 205 having different shapes from each other is limited to at least 100 and at most 2,000. When the number of types of the light adjustment structures 205 having different shapes from each other is more than 2,000, a problem that the brightness is lowered due to the high haze may occur.

As shown in FIG. 3, these light adjustment structures 205 of the first light adjustment structure layer 202 of the embodiment includes rows A to I of light adjustment structures. That is these light adjustment structures 205 are divided into 9 rows for the following description in the embodiment, but the invention is not limited thereto; namely, the number of rows of the light adjustment structures 205 may be adjusted according to actual needs. Specifically, these rows A to I of light adjustment structures of the embodiment are arranged along straight line segments S1 to S9, respectively, and these straight line segments S1 to S9 extend in a direction parallel to the direction X. The lengths L1 and L2 of the short axis Sa of the adjacent two light adjustment structures 205 in each row of light adjustment structures (taking the row I of light adjustment structures as an example) are equal to each other. Further, taking the row B of light adjusting structures (the light adjusting structures 205 arranged along the straight line segment S2) and the row C of light adjusting structures (the light adjusting structures 205 arranged along the straight line segment S3) as an example, the length L3 of the short axis Sa of each light adjustment structure 205 in the row B of light adjustment structures and the length L4 of the short axis Sa of each light adjustment structure 205 in the row C of light adjustment structures are not equal to each other. In addition, the length of the long axis La of these light adjusting structures 205 in the rows A to I of light adjusting structures and the thickness T of these light adjusting structures 205 are designed to be changed in a random manner. For example, at least two of these light adjusting structures 205 have different lengths of the long axis La and different thicknesses T. For example, the lengths L5 and L6 of the long axis La of adjacent two light adjustment structures 205 in the row I of light adjustment structures are not equal to each other. By the above-mentioned design, each row of light adjustment structures can be more irregular to solve the defects of hot spots and muras.

In the embodiment as shown in FIG. 3, it is to be noted that the range of length of the long axis La of each light adjustment structure 205 (for example, the lengths L5 and L6 shown in FIG. 3) is, for example, between 10 um (micron) and 500 um, but the invention is not limited thereto; and the range of length of the short axis Sa of each light adjustment structure 205 (for example, the lengths L1, L2, L3, and L4 shown in FIG. 3) is, for example, between 1 um and 100 um. Therefore, the ratio of the short-axis length to the long-axis length of light adjustment structure is selected to be between 0.002 and 10, but the invention is not limited thereto. As shown in FIG. 2, the range of the thickness T of each light adjustment structure 205 is, for example, between 0.1 um and 50 um. In addition, any one of the light adjustment structures 205 and its adjacent light adjustment structures 205 are not the same in the embodiment.

In the embodiment, it is to be noted that the first light adjustment structure layer 202 is disposed on the first surface 203 of the substrate 201, but the invention is not limited thereto. In other embodiments, the first light adjustment structure layer 202 may be disposed on the second surface 204 of the substrate 201.

In the embodiment, it is to be noted that each of the light adjusting structures 205 is, for example, a hemispherical three-dimensional structure having its arc curve protrude away from the first surface 203 of the substrate 201, but the invention is not limited thereto. In other embodiments, each of the light adjusting structures 205 is, for example, a hemispherical three-dimensional structure having its arc curve bend toward the first surface 203 of the substrate 201.

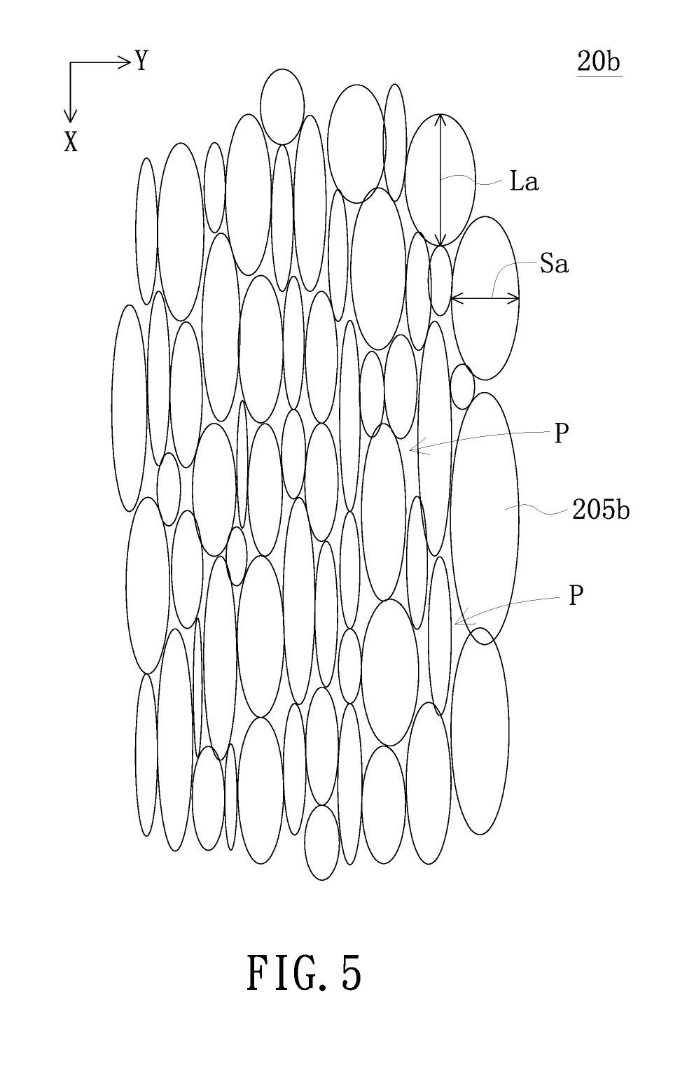

Please refer to FIG. 4, which is a schematic top view of a light adjustment film 20a in accordance with another embodiment of the invention. The light adjustment film 20a of the embodiment is similar to the light adjustment film 20 shown in FIGS. 2 and 3 except that a plurality of rows A′ ‘to G′ of light adjustment structures are arranged along the continuous curved line segments C1 to C7, and these continuous curved line segments C1 to C7 extend in the direction X, respectively. At least two of the light adjustment structures 205a of each row of light adjustment structures are partially overlapped with each other. For example, the second and third light adjustment structures 205a in the row B′ of light adjustment structures are partially overlapped with each other. In addition, taking the rows E′ and F′ of light adjustment structures as an example, at least one of the light adjustment structures 205a in the row E′ of light adjustment structures and at least one of the light adjustment structures 205a in the row F′ of light adjustment structures are partially overlapped with each other. For example, the seventh light adjustment structures 205a in the row E′ of light adjustment structures and the fifth light adjustment structures 205a in the row F′ of light adjustment structures are partially overlapped with each other. By partially overlapping at least two of the light adjustment structures 205a in the same or different rows of light adjustment structures with each other, the range in which the light adjustment structures 205a are distributed on the first surface 203 is increased and thereby reducing the defect that being incapable of achieving the symmetry between the vertical viewing angle and the horizontal viewing angle caused by the first surface 203 having the planar region P without the light adjustment structures 205a distributed thereon. Therefore, in the embodiment of FIG. 3, by partially overlapping at least two of the light adjustment structures 205 in the same or different rows of light adjustment structures with each other, the range in which the light adjustment structures 205a are distributed on the first surface 203 is increased and the symmetrical effect between the vertical viewing angle and the horizontal viewing angle is achieved.

In the embodiment, it should be noted that the length of the long axis La, the length of the short axis Sa and the thickness T of these light adjustment structures 205a in the rows A′ to G′ of light adjustment structures are designed in a manner similar to those shown in FIGS. 2 and 3, and no redundant detail is to be given herein.

In the embodiment, it is to be noted that these continuous curved line segments C1 to C7 are, for example, line segments defined by the sine function or the cosine function, respectively, but the invention is not limited thereto. In other embodiments, these continuous curved line segments C1 to C7 are, for example, line segments defined by the sine function and the cosine function, respectively. For example, these continuous curved line segments C1, C3, C5 and C7 are line segments defined by the sine function and these continuous curved line segments C2, C4 and C6 are line segments defined by the cosine function; or these continuous curved line segments C1, C2, C3 and C4 are line segments defined by the sine function and these continuous curved line segments C5, C6 and C7 are line segments defined by the cosine function. In the embodiment of FIG. 4, the rows A′ to G′ of light adjustment structures are arranged along the continuous curved line segments C1 to C7, respectively, and have a relatively irregular arrangement, compared with that in the embodiment of FIG. 3 in which the rows A to I of light adjustment structures are arranged along the straight line segment S1 to S9, respectively; and therefore, the effect of solving hot spots and muras can be further improved.

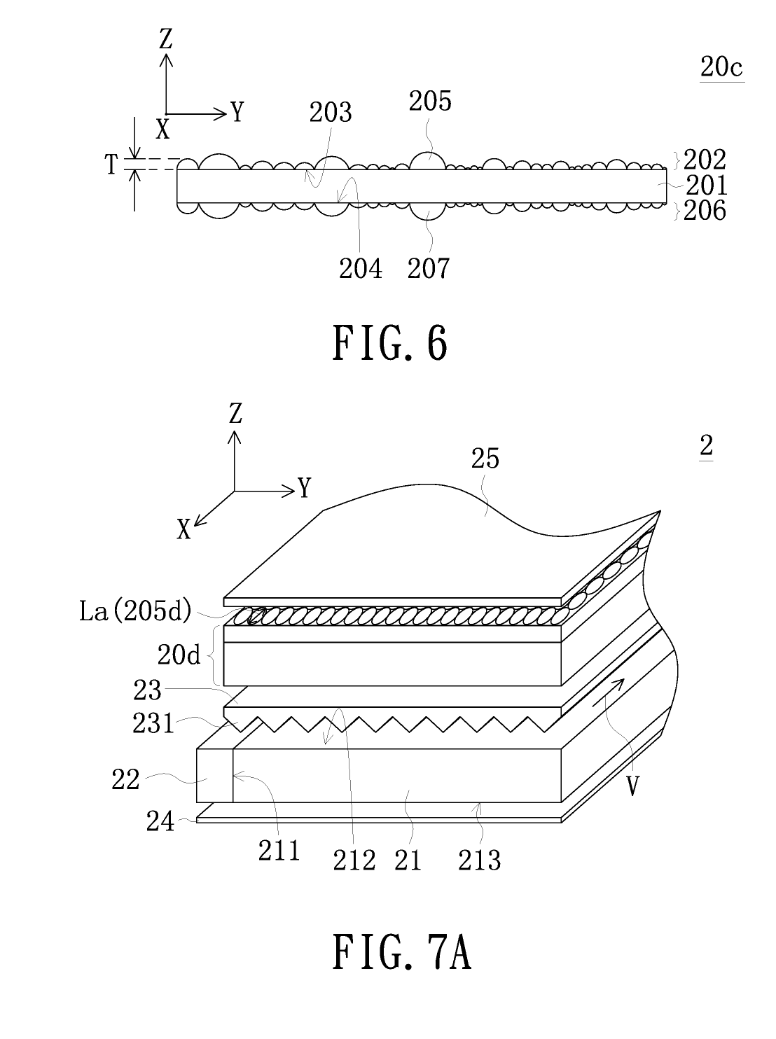

Please refer to FIG. 5, which is a schematic top view of a light adjustment film 20b in accordance with another embodiment of the invention. The light adjustment film 20b of the embodiment is similar to the light adjustment film 20 shown in FIGS. 2 and 3 except that the length of the long axis La, the length of the short axis Sa, the thickness T and the arrangement of the light adjustment structures 205b of the embodiment are designed in a random manner, and at least one of the light adjustment structures 205b and its adjacent light adjustment structures 205b are partially overlapped each other. In addition, the arrangement of the light adjusting structures 205b in the embodiment of FIG. 5 is more irregular than that of FIGS. 3 and 4; and therefore, the effect of solving hot spots and muras can be further improved.

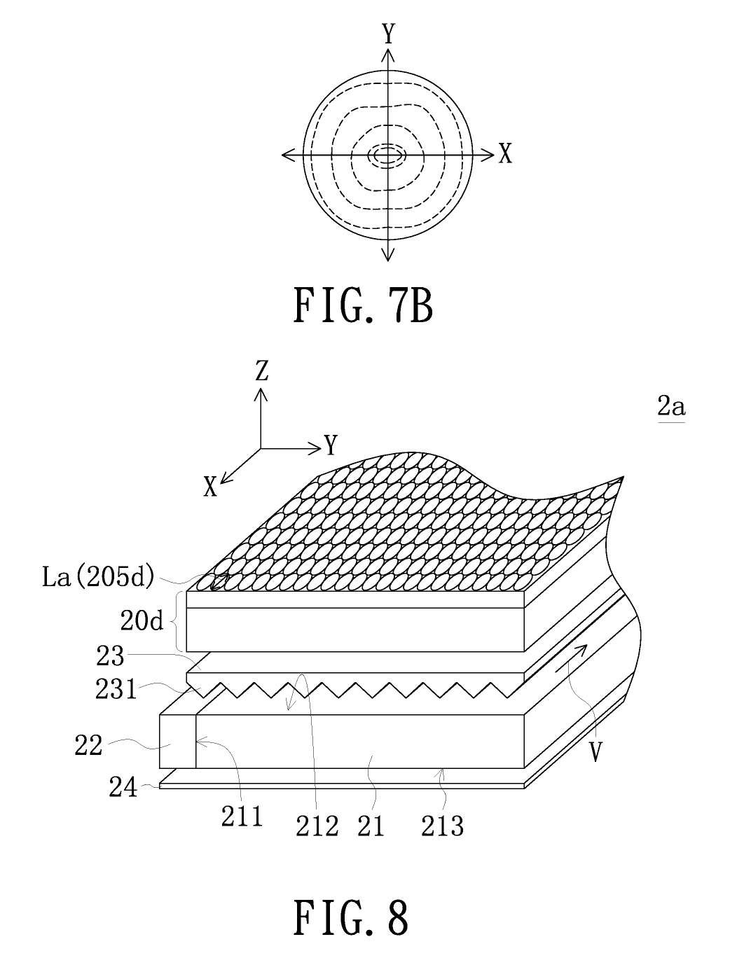

Please refer to FIG. 6, which is a schematic cross-sectional view of a light adjustment film 20c in accordance with another embodiment of the invention. The light adjustment film 20c of the embodiment is similar to the light adjustment film 20 shown in FIGS. 2 and 3 except that the light adjustment film 20c of the embodiment further includes a second light adjustment structure Layer 206 as shown in FIG. 6. The second light adjustment structure layer 206 is disposed on the second surface 204 of the substrate 201, and the second light adjustment structure layer 206 includes a plurality of light adjustment structures 207. The length of the long axis La, the length of the short axis Sa, the thickness T and the arrangement of these light adjusting structures 207 in the second light regulating structure layer 206 are similar to those of the embodiments shown in FIGS. 2 to 5, but the invention is not limited thereto.

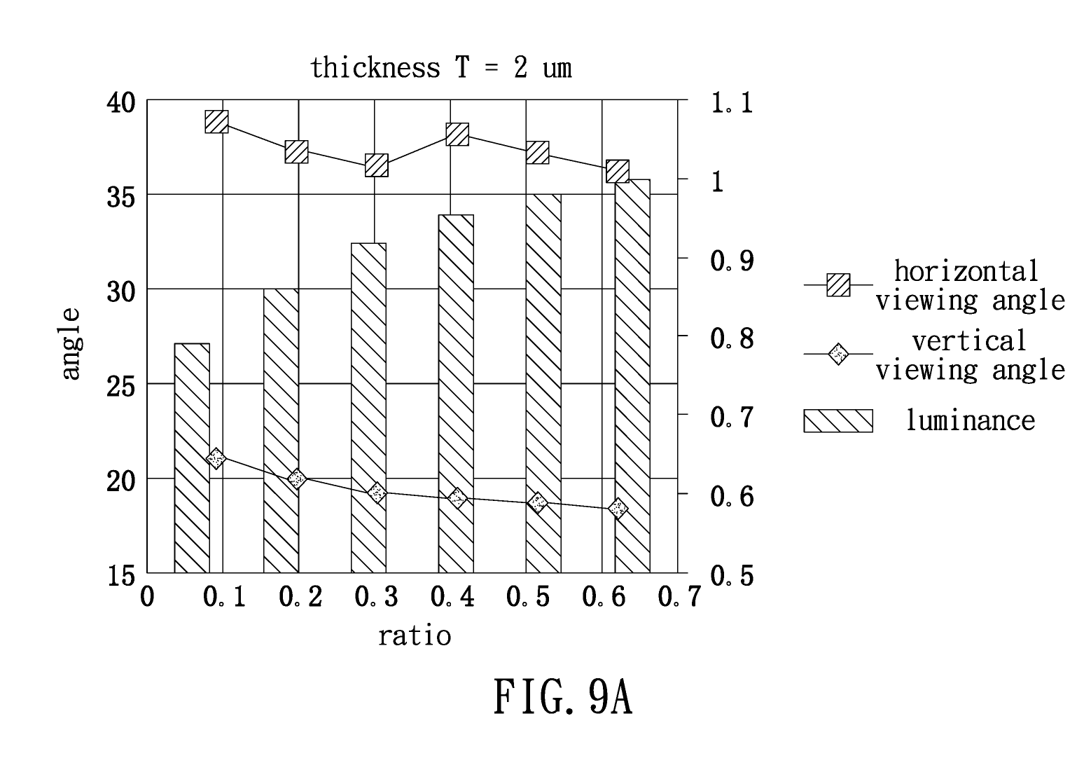

Please refer to FIG. 7A, which is a schematic partial perspective view of a backlight module 2 in accordance with an embodiment of the invention. As shown in FIG. 7A, the backlight module 2 of the embodiment includes a light adjustment film 20d, a light guide plate 21, a light source 22, a prism film 23, a reflection sheet 24 and a diffusion sheet 25. The light guide plate 21 has a light entrance surface 211, a light exit surface 212 and a bottom surface 213 opposite to the light exit surface 212. The light source 22 is disposed beside the light entrance surface 211 of the light guide plate 21 to provide a light beam to the light guide plate 21. The prism film 23 is disposed above the light exit surface 212 of the light guide plate 21. The light adjustment film 20d is disposed above the prism film 23. The reflection sheet 24 is disposed below the bottom surface 213 of the light guide plate 21. The diffusion sheet 25 is disposed above the light adjustment film 20d.

In the embodiment as shown in FIG. 7A, the light guide plate 21 is an inverse prism light guide plate and the prism film 23 is an inverse prism film. The prism film 23 includes a plurality of strip-like structures 231 protruding in the direction toward the light exit surface 212 of the light guide plate 21, and the longitudinal direction V of these strip-like structures 231 is parallel to the direction X; that is, the longitudinal direction V of these strip-like structures 231 of the prism film 23 is parallel to the long axis La of these light adjustment structures 205d of the light adjustment film 20d. Further, in the embodiment, the description of the related structure of the light adjustment film 20d has been provided in the preceding paragraphs and no redundant detail is to be given herein.

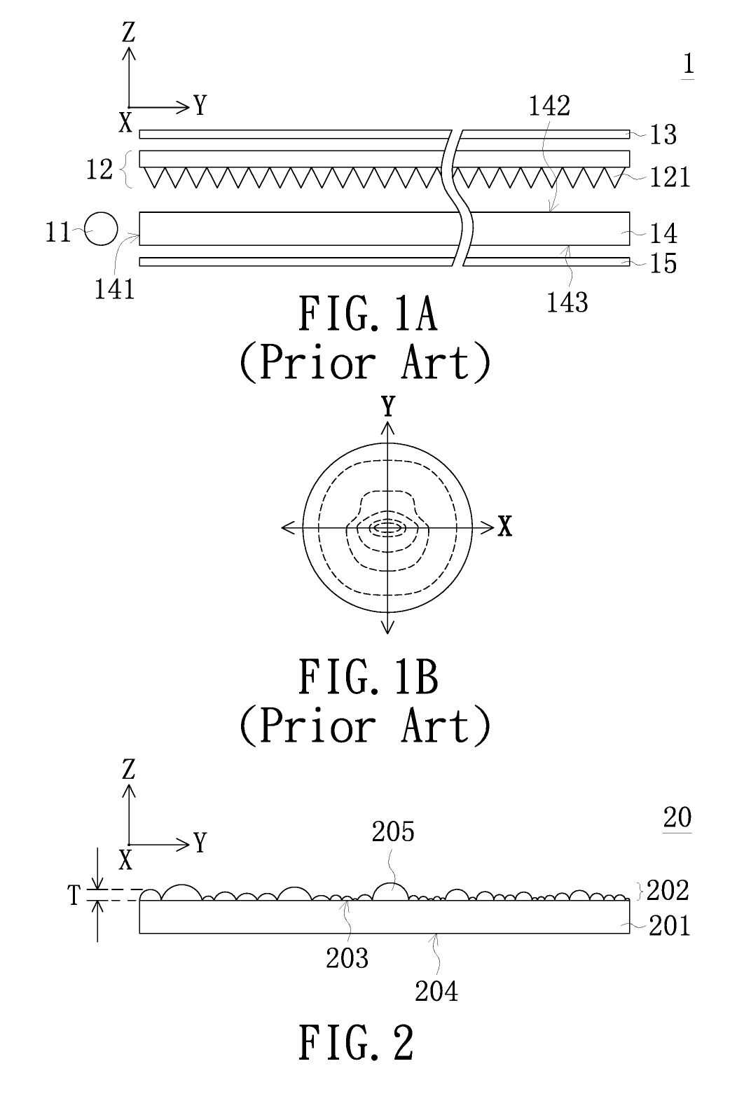

Please refer to FIG. 7B, which is a viewing view of the horizontal and vertical viewing angles of the outgoing light beam of FIG. 7A. As shown in FIG. 7B, because the light adjustment film 20d is disposed above the inverse prism film 23, the difference between the horizontal viewing angle (the direction X) and the vertical viewing angle (the direction Y) of the outgoing light beam of the backlight module 2 mounted with the inverse prism film 23 becomes small (relative to FIG. 1B); therefore, the light adjustment film 20d can effectively expanded the vertical viewing angle (the direction Y) of the prism film 23 and have the horizontal viewing angle (the direction X) have smaller change, thereby making the horizontal viewing angle and the vertical viewing angle more symmetrical. As a result, when the user rotates the screen and views the screen in different directions, the visual discomfort of the conventional backlight module 1 can be eliminated.

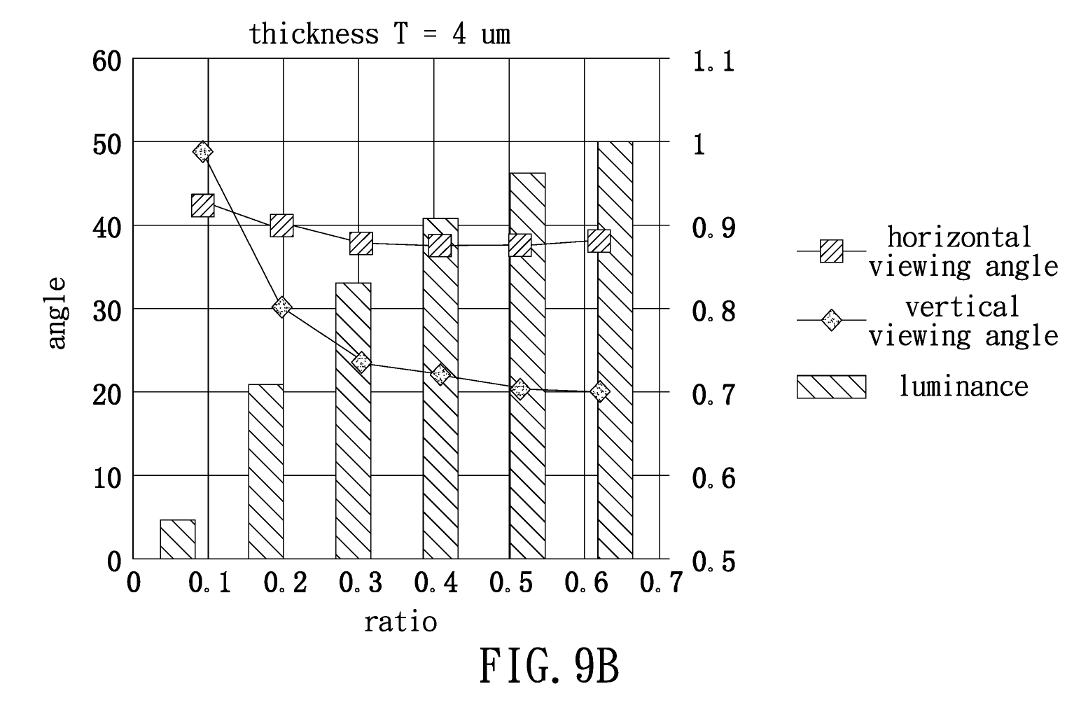

Please refer to FIG. 8, which is a partial perspective structural view of a backlight module 2a in accordance with another embodiment of the invention. The backlight module 2a of the embodiment is similar to the backlight module 2 shown in FIG. 7 except that the backlight module 2a of the embodiment shown in FIG. 8 omits the diffusion sheet 25 in FIG. 7. In the embodiment, the function of the diffusion sheet 25 is replaced by the light adjustment film 20d. Namely, the light adjustment film 20d can achieve the function of the viewing angle adjusting and also achieve the function of the light homogenizing of the diffusion sheet 25.

It should be noted that the backlight modules 2 and 2a in respective FIGS. 7 and 8 each are provided with the light adjustment film 20d, but the invention is not limited thereto. In other embodiments, the backlight modules 2 and 2a each may be provided with any one of the light adjustment films 20, 20a, 20b, and 20c shown in FIGS. 2, 3, 4, 5 and 6, respectively.

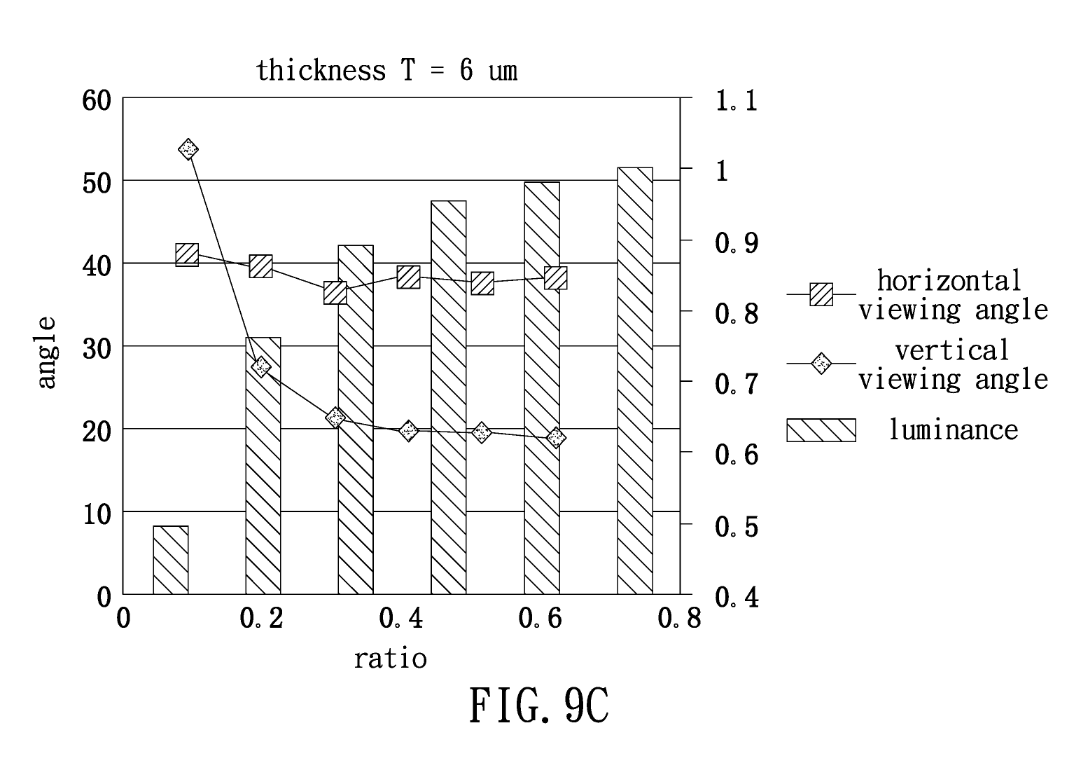

FIG. 9A is a graph showing the relationship between the ratio of the short-axis length to the long-axis length and the viewing angle and the luminance in the case where the thickness T of the light adjustment structure is 2 um. FIG. 9B is a graph showing the relationship between the ratio of the short-axis length to the long-axis length and the viewing angle and the luminance in the case where the thickness T of the light adjustment structure is 4 um. FIG. 9C is a graph showing the relationship between the ratio of the short-axis length to the long-axis length and the viewing angle and the luminance in the case where the thickness T of the light adjustment structure is 6 um. As shown in FIGS. 9A to 9C, when the thickness T is between 2 um and 6 um, the smaller the ratio of the short-axis length to the long-axis length of the light adjustment structure, the larger the angle of the corresponding vertical viewing angle; and the angle of the horizontal viewing angle is almost the same under the different ratios of the short-axis length to the long-axis length. However, the luminance will be too low if the ratio of the short-axis length to the long-axis length of the light adjustment structure is too small (e.g., the ratio is about 0.1); and the angle of the vertical viewing angle will become small if the ratio of the short-axis length to the long-axis length of the light adjustment structure is too large (e.g., the ratio is about 0.8). In addition, in the case where the ratio of the short-axis length to the long-axis length of the light adjustment structure is the same, the thickness T also influences the angle of the vertical viewing angle; specifically, the larger the thickness T (e.g., the thickness T is 6 um), the larger the angle of the vertical viewing angle. Therefore, preferably the ratio of the short-axis length to the long-axis length of the light adjustment structure is selected to be between 0.093 and 0.6 and the thickness T is selected to be between 2 um and 6 um, so that the luminance is not too low and the vertical viewing angle has a larger angle. And thus, the effect of expanding the vertical viewing angle (direction Y) of the prism film 23 is achieved, the difference between the horizontal and vertical viewing angles of the outgoing light beam is reduced, and the vertical viewing angle and the horizontal viewing angle are more symmetrical.

In summary, the embodiments of the invention have at least one of the following advantages. The light adjustment film of the embodiment of the invention has a light adjustment structure layer including a plurality of light adjustment structures which is composed of at least 100 types of structures having different shapes from each other. By applying the light adjustment film of the embodiment of the invention to a backlight module, the vertical viewing angle of the inverse prism film is expended effectively, the vertical viewing angle and the horizontal viewing angle are more symmetrical and the visual defects of hot spots and muras are avoided effectively.

The foregoing description of the preferred embodiment of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like is not necessary limited the claim scope to a specific embodiment, and the reference to particularly preferred exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the invention as defined by the following claims. Moreover, no element and component in the disclosure is intended to be dedicated to the public regardless of whether the element or component is explicitly recited in the following claims. Furthermore, the terms such as the first stop part, the second stop part, the first ring part and the second ring part are only used for distinguishing various elements and do not limit the number of the elements.

What is claimed is:

1. A light adjustment film, comprising:
a substrate having a first surface and a second surface opposite to each other; and
a first light adjustment structure layer disposed on the first surface of the substrate, wherein the first light adjustment structure layer comprises a plurality of light adjustment structures, each of the light adjustment structures has a long axis, a short axis and a thickness, the long axis of the light adjustment structures is parallel to an extending direction, and the light adjustment structures are composed of at least 100 types of structures having different shapes from each other.

2. The light adjustment film according to claim 1, wherein the light adjustment structures comprise a first row of light adjustment structures and a second row of light adjusting structures, the lengths of the short axis of the adjacent two light adjustment structures in the first row of light adjustment structures are equal to each other, and the length of the short axis of each of the light adjustment structures in the first row of light adjustment structures and the length of the short axis of each of the light adjustment structures in the second row of light adjustment structures are not equal to each other.

3. The light adjustment film according to claim 2, wherein in the first row of light adjustment structures and the second row of light adjustment structures, at least two of the light adjustment structures have different lengths in the long axis and different thicknesses.

4. The light adjustment film according to claim 2, wherein the light adjustment structures in the first row of light adjustment structures are arranged along a first straight line segment, the light adjustment structures in the second row of light adjustment structures are arranged along a second straight line segment, and the first straight line segment and the second straight line segment are parallel to the extending direction.

5. The light adjustment film according to claim 2, wherein the light adjustment structures in the first row of light adjustment structures are arranged along a first continuous curved line segment, the light adjustment structures in the second row of light adjustment structures are arranged along a second continuous curved line segment, and the first continuous curved line segment and the second continuous curved line segment are extend in the extending direction.

6. The light adjustment film according to claim 5, wherein the first continuous curved line segment and the second continuous curved line segment are line segments defined by a sine function or a cosine function.

7. The light adjustment film according to claim 6, wherein the first continuous curved line segment is a line segment defined by a sine function, and the second continuous curved line segment is a line segment defined by a cosine function.

8. The light adjustment film according to claim 2, wherein at least two of the light adjustment structures in the first row of light adjustment structure are partially overlapped with each other, and at least two of the light adjustment structures in the second row of light adjustment structure are partially overlapped with each other.

9. The light adjustment film according to claim 8, wherein at least one of the light adjustment structures in the first row of light adjustment structures and at least one of the light adjustment structures in the second row of light adjustment structures are partially overlapped with each other.

10. The light adjustment film according to claim 1, wherein the length of the long axis, the length of the short axis and the thickness of the light adjustment structures are changed randomly.

11. The light adjustment film according to claim 1, wherein at least one of the light adjustment structures and its adjacent light adjustment structure are partially overlapped with each other.

12. The light adjustment film according to claim 1, wherein each of the light adjustment structures is a hemispherical three-dimensional structure having its arc curve protrude away from the first surface or a hemispherical three-dimensional structure having its arc curve bend toward the first surface.

13. The light adjustment film according to claim 1, further comprising a second light adjustment structure layer disposed on the second surface of the substrate.

14. The light adjustment film according to claim 1, wherein the light adjustment structures are composed of at most 2,000 types of structures having different shapes from each other.

15. The light adjustment film according to claim 1, wherein the length of the long axis is between 10 um and 500 um, the length of the short axis is between 1 um and 100 um, and the thickness is between 0.1 um and 50 um.

16. The light adjustment film according to claim 1, wherein a ratio of the length of the short axis to the length of the long axis is between 0.002 and 10 and the thickness is between 0.1 um and 50 um.

17. The light adjustment film according to claim 1, wherein any one of the light adjustment structures and its adjacent light adjustment structure are not the same.

18. A backlight module, comprising:
a light guide plate having a light entrance surface, a light exit surface and a bottom surface opposite to the light exit surface;
a light source disposed beside the light entrance surface of the light guide plate to provide a light beam to the light guide plate;
a prism film disposed above the light exit surface of the light guide plate;
a light adjustment film as claimed in any one of claims 1 to 17, disposed above the prism film; and
a reflection sheet disposed below the bottom surface of the light guide plate.

19. The backlight module according to claim 18, further comprising a diffusion sheet disposed above the light adjustment film.

20. The backlight module according to claim 18, wherein the prism film is an inverse prism film, the inverse prism film comprises a plurality of strip-like structures protruding toward the light exit surface of the light guide plate, and a longitudinal direction of the strip-like structures is parallel to the extending direction.

21. The backlight module according to claim 18, wherein the light guide plate comprises an inverse prism light guide plate.
